(19) United States
(12) Patent Application Publication
(10) Pub. No.: US 2015/0212803 A1
(43) Pub. Date: Jul. 30, 2015

(54) SYSTEMS AND METHODS FOR OPTIMIZING SOURCE CODE COMPILING

(71) Applicant: Google Inc., Mountain View, CA (US)

(72) Inventors: Daniel Kenneth Clifford, Baldham, DE (US); Vyacheslav Egorov, Aarhus C (DK)

(21) Appl. No.: 13/933,050

(22) Filed: Jul. 1, 2013

Related U.S. Application Data
(60) Provisional application No. 61/827,413, filed on May 24, 2013.

(51) Int. Cl. G06F 9/45

(52) U.S. Cl. CPC G06F 8/443

(57) ABSTRACT

Systems and methods for compiling source code are provided. In some aspects, a method includes receiving one or more code stubs configured to be inline cached at one or more call sites of a native code generated by a baseline compiler from a source code. Each of the one or more code stubs is based on an intermediate representation between the source code and the native code. The method also includes translating the source code into the intermediate representation, inlining the one or more code stubs into the translated source code, and optimizing, by an optimizing compiler, at least one of the translated source code and the inlined one or more code stubs.

### CROSS-REFERENCES TO RELATED APPLICATIONS

The present application claims the benefit of U.S. Provisional Patent Application Ser. No. 61/827,413, titled “Systems and Methods for Optimizing Source Code Compiling,” filed on May 24, 2013, which is hereby incorporated by reference in its entirety for all purposes.

### FIELD

The subject technology generally relates to compilers and, in particular, relates to systems and methods for optimizing source code compiling.

### BACKGROUND

A baseline compiler may be used to transform source code (e.g., a high-level programming language) into native code (e.g., a lower-level language) such that the native code can be executed by a computer. Baseline compilers typically perform the transformation in a quick manner without analyzing whether the source code can be further optimized before being transformed into the native code. As a result, the native code generated by baseline compilers can typically be further optimized through additional processing.

### SUMMARY

According to various aspects of the subject technology, a computer-implemented method for compiling source code is provided. The method comprises receiving one or more code stubs configured to be inline cached at one or more call sites of a native code generated by a baseline compiler from a source code. Each of the one or more code stubs is based on an intermediate representation between the source code and the native code. The method also comprises translating the source code into the intermediate representation, inlining the one or more code stubs into the translated source code, and optimizing, by an optimizing compiler, at least one of the translated source code and the inlined one or more code stubs.

According to various aspects of the subject technology, a system comprising memory and a processor is provided. The memory comprises instructions for compiling source code. The processor is configured to execute the instructions to receive one or more code stubs configured to be inline cached at one or more call sites of a native code generated by a baseline compiler from a source code. Each of the one or more code stubs is based on an intermediate representation between the source code and the native code. The processor is also configured to execute the instructions to translate the source code into the intermediate representation, inline the one or more code stubs into the translated source code, and optimize, by an optimizing compiler, at least one of the translated source code and the inlined one or more code stubs.

According to various aspects of the subject technology, a non-transitory machine-readable medium encoded with executable instructions for a method of compiling source code is provided. The method comprises receiving one or more code stubs configured to be inline cached at one or more call sites of a native code generated by a baseline compiler from a source code. Each of the one or more code stubs is in an intermediate representation between the source code and the native code. The method also comprises translating the source code into the intermediate representation, determining one or more locations in the translated source code for inlining the one or more code stubs, inlining the one or more code stubs into the one or more locations in the translated source code, and optimizing, by an optimizing compiler, at least one of the translated source code and the inlined one or more code stubs.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a baseline compiler using inline caching as an optimization technique.

FIG. 2 illustrates an example of adaptive recompilation, which is another optimization technique that may be performed by an optimizing compiler.

FIG. 3 illustrates an example of a method for optimizing code using both inline caching and adaptive recompilation techniques, in accordance with various aspects of the subject technology.

FIG. 4 illustrates an example of a situation in which source code and code stubs may be optimized using both inline caching and adaptive recompilation techniques, in accordance with various aspects of the subject technology.

FIG. 5 conceptually illustrates an electronic system with which aspects of the subject technology may be implemented.

### DETAILED DESCRIPTION

In the following detailed description, numerous specific details are set forth to provide a full understanding of the subject technology. It will be apparent, however, that the subject technology may be practiced without some of these specific details. In other instances, structures and techniques have not been shown in detail so as not to obscure the subject technology.

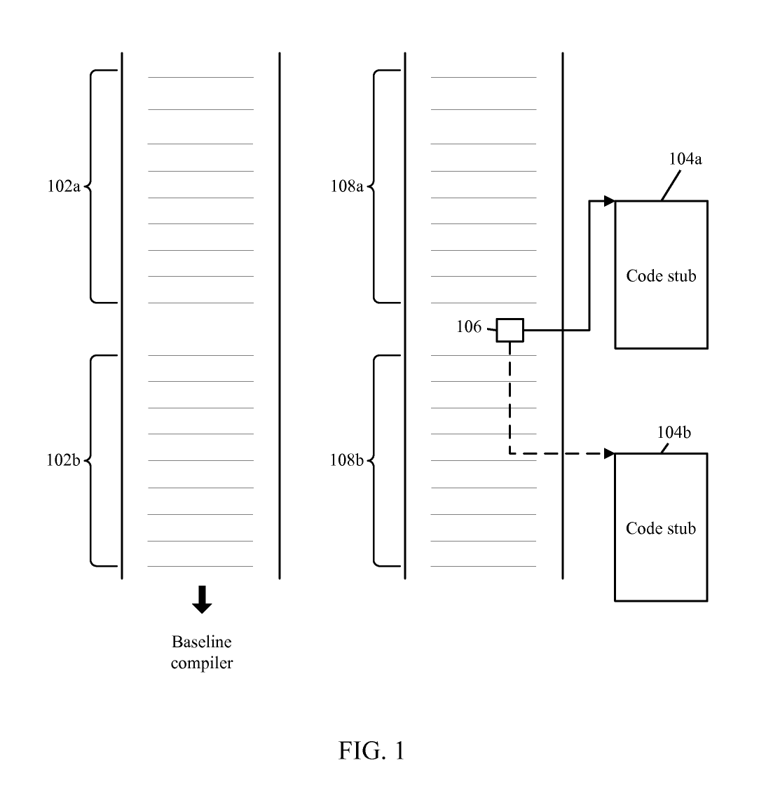

FIG. 1 illustrates an example of a baseline compiler using inline caching as an optimization technique. As shown in FIG. 1, source code 102 (e.g., illustrated as source code portions 102a and 102b) may be compiled by the baseline compiler to generate corresponding native code 108 (e.g., illustrated as native code portions 108a and 108b). Inline caching may be used by the baseline compiler to speed up late binding by remembering the results of a previous dynamic lookup directly at a call site of native code 108, such as at call site 106. Inline caching may be especially useful for dynamically typed languages where dynamic lookup is an integral part of most, if not all, language features and early binding may not be possible. Inline caching may be based on the empirical observation that the objects that occur at a particular call site may often be of the same type or belong to a small set of types. In those cases, performance can be increased greatly by caching the result of a method lookup “inline” (e.g., directly at the call site). Caching may be implemented by generating a new code stub for each change in the state of the inline cache. As shown in FIG. 1, code stub 104a may be cached at call site 106. If the state of the inline cache changes, then another code stub, such as code stub 104b, may be cached at call site 106 instead.

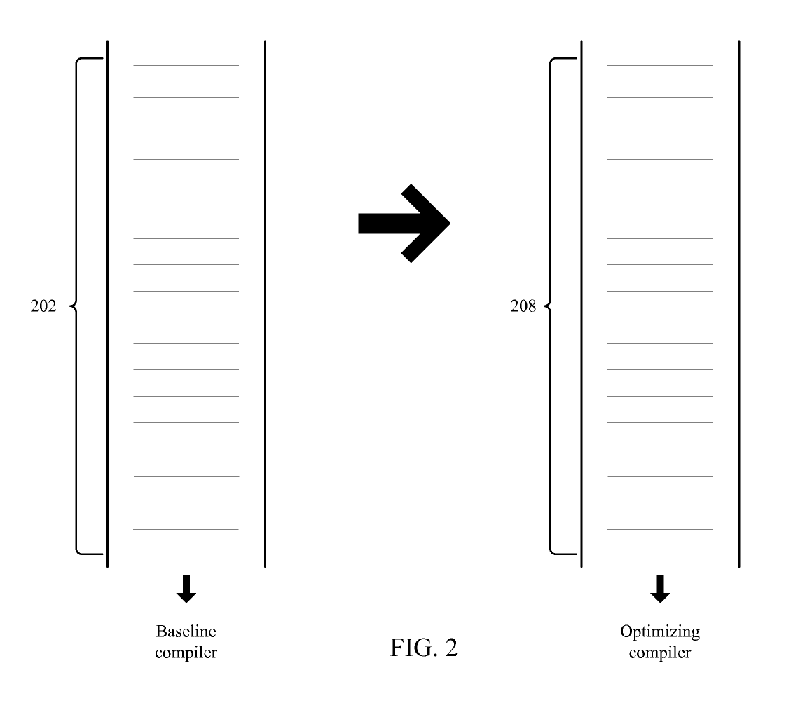

FIG. 2 illustrates an example of adaptive recompilation, which is another optimization technique that may be performed by an optimizing compiler. Adaptive recompilation may involve the recompilation of one or more portions of source code 202 based on a current execution profile. By compiling during execution, code generated by the optimizing compiler may be tailored to reflect the program's run-time environment, thereby allowing potentially more efficient code to be produced. In some aspects, the optimizing compiler may translate source code 202 into an intermediate representation (IR) between source code 202 and the native code. The optimizing compiler may then analyze the translated source code 208 (in the intermediate representation) to identify one or more optimizations that can be implemented.

Inline caching and adaptive recompilation may be used together to generate optimized code. One way to implement this is to use information collected by inline caches to drive speculative optimizations in the optimizing compiler. However, the code stubs from inline caching are typically written in assembly language, which may be different from the intermediate representation of code that the optimizing compiler operates on. As a result, the code stubs may be non-transparent to the optimizing compiler and code duplication may occur between the baseline compiler, the stubs themselves, and/or different stages of the optimizing compiler.

According to various aspects of the subject technology, systems and methods for optimizing code using both inline caching and adaptive recompilation techniques are provided. According to certain aspects, instead of being handwritten in assembly language, code stubs may be described in an intermediate representation, compiled to optimized native code by an optimizing compiler, and then inline cached into call sites of a native code generated by a baseline compiler from a source code. When the source code and the code stubs are provided to an optimizing compiler, the optimizing compiler only has to translate the source code into the intermediate representation. In some aspects, the code stubs may be inlined into the translated source code (in the intermediate representation), thereby allowing the optimizing compiler to analyze this code in a straight-line manner to identify one or more optimizations. Because the code stubs in the intermediate representation are sufficient to describe the functionality of these stubs for all processor architectures, the code stubs do not need to be written in assembly language. Moreover, no secondary compiler or translation mechanism is required to create inline cache code stubs other than the same optimizing compiler that is used for adaptive recompilation.

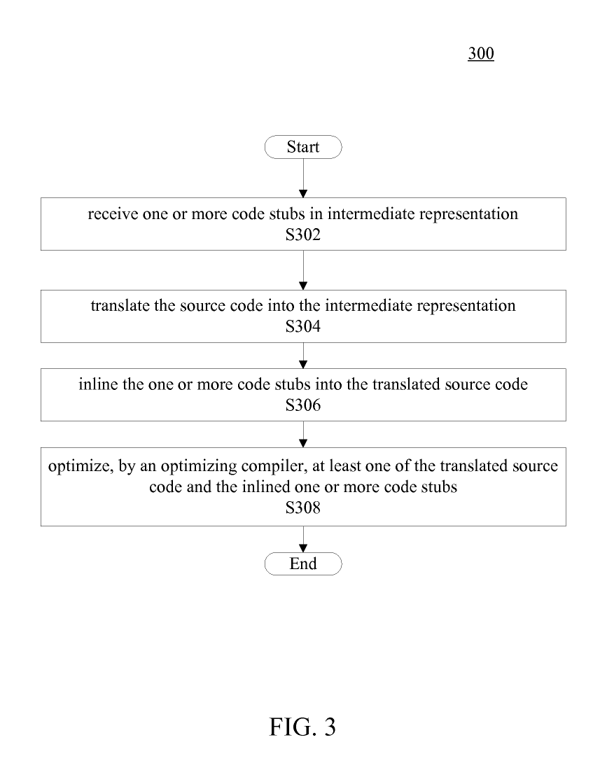

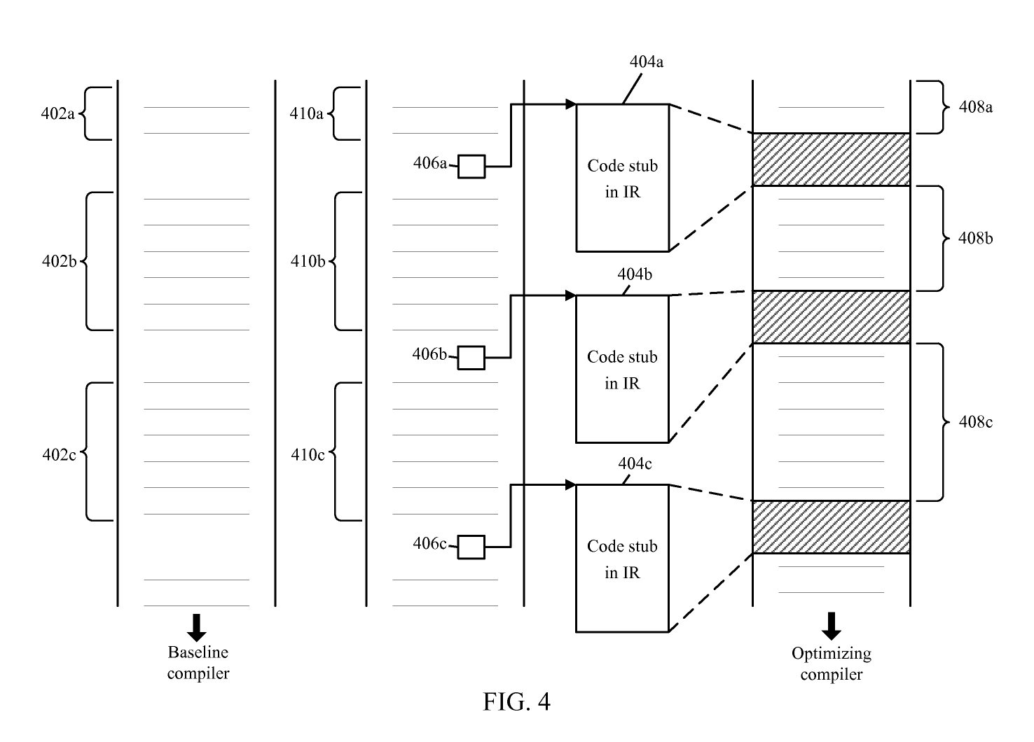

FIG. 3 illustrates an example of method 300 for optimizing code using both inline caching and adaptive recompilation techniques, in accordance with various aspects of the subject technology. FIG. 4 illustrates an example of a situation in which source code 402 (e.g., illustrated as source code portions 402a, 402b, and 402c) and code stubs 404a, 404b, and 404c may be optimized using both inline caching and adaptive recompilation techniques, in accordance with various aspects of the subject technology. Although method 300 is described herein with reference to the example of FIG. 4, method 300 is not limited to this example. Furthermore, although method 300 is illustrated in the order shown in FIG. 3, it is understood that method 300 may be implemented in a different order.

According to step S302, a processor (e.g., from a computer being used to compile source code 402) may receive one or more code stubs, such as code stubs 404a, 404b, and 404c, in an intermediate representation between source code 402 and native code 410 (e.g., illustrated as native code portions 410a, 410b, and 410c). Native code 410 may be generated by the baseline compiler from source code 402. For example, the baseline compiler may compile source code portions 402a, 402b, and 402c to generate native code portions 410a, 410b, and 410c, respectively. Code stubs 404a, 404b, and 404c may be configured to be inline cached at call sites 406a, 406b, and 406c, respectively, of native code 410. Although code stubs 404a, 404b, and 404c are in the intermediate representation, it is understood that these code stubs may be in other formats that would allow an optimizing compiler to quickly optimize the code stubs. For example, code stubs 404a, 404b, and 404c may each be in a source code representation and include information allowing a corresponding code stub in the source code representation to be generated in the intermediate representation without any runtime type information. The resulting intermediate representation may be sufficient for the optimizing compiler to generate a corresponding code stub.

According to step S304, the optimizing compiler may translate source code 402 into the intermediate representation, as illustrated by translated code 408 (e.g., illustrated as translated code portions 408a, 408b, and 408c). For example, translated code portion 408a illustrates the intermediate representation of source code portion 402a, translated code portion 408b illustrates the intermediate representation of source code portion 402b, and translated code portion 408c illustrates the intermediate representation of source code portion 402c. Since code stubs 404a, 404b, and 404c are already in the intermediate representation, the optimizing compiler does not need to translate these code stubs into the intermediate representation.

According to step S306, code stubs 404a, 404b, and 404c may be inlined into translated code 408. For example, the locations of where to insert these code stubs can be determined by observing the corresponding locations of call sites 406a, 406b, and 406c relative to native code portions 410a, 410b, and 410c, each of which corresponds to a respective source code portion (e.g., source code portion 402a, 402b, or 402c). Code stubs 404a, 404b, and 404c may then be inlined into translated code 408 at the appropriate locations so that translated code 408 and inlined code stubs 404a, 404b, and 404c remain substantially in the same order as source code 402 and non-inlined code stubs 404a, 404b, and 404c. However, according to certain aspects, the optimizing compiler may inline code stubs 404a, 404b, and 404c in a different order depending on whether it is more efficient to do so. By inlining code stubs 404a, 404b, and 404c into translated code 408, the optimizing compiler may analyze this code in a straight-line manner to identify one or more optimizations.

According to step S308, the optimizing compiler may optimize translated code 408 and/or the inlined code stubs 404a, 404b, and 404c to generate optimized native code. For example, the optimizing compiler may identify and remove any redundant operations from translated source code 408 and/or inlined code stubs 404a, 404b, and 404c. As a result, compared to native code 410 that is generated by the baseline compiler, the optimized native code can be more efficiently executed by a processor. In some aspects, the optimizing compiler may compile one or more of code stubs 404a, 404b, and 404c into optimized native code, which can then be inline cached at appropriate call sites of native code 410.

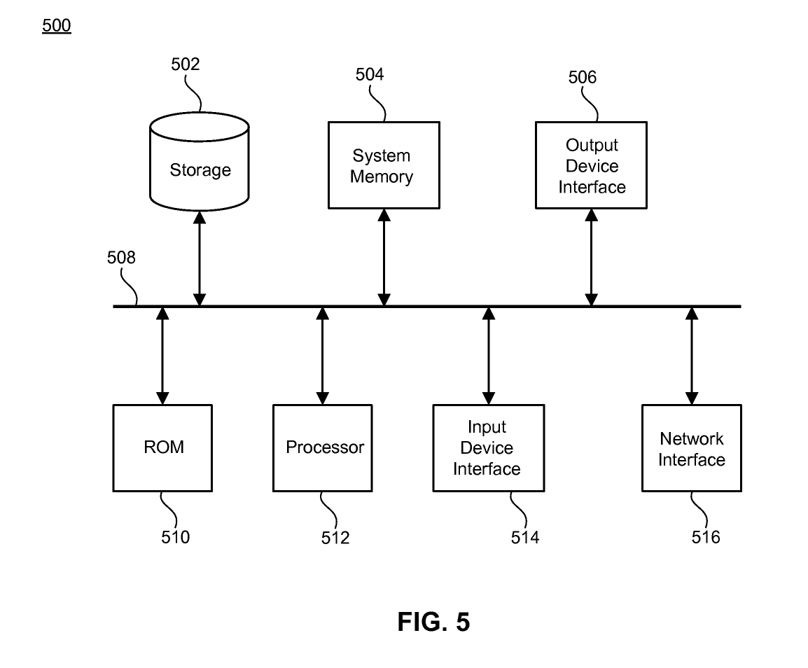

FIG. 5 conceptually illustrates electronic system 500 with which aspects of the subject technology may be implemented. Electronic system 500, for example, can be a desktop computer, a laptop computer, a tablet computer, a server, a phone, a personal digital assistant (PDA), any device that can be used to compile code, or generally any electronic device that transmits signals over a network. Such an electronic system includes various types of computer readable media and interfaces for various other types of computer readable media. Electronic system 500 includes bus 508, processing unit(s) 512, system memory 504, read-only memory (ROM) 510, permanent storage device 502, input device interface 514, output device interface 506, and network interface 516, or subsets and variations thereof.

Bus 508 collectively represents all system, peripheral, and chipset buses that communicatively connect the numerous internal devices of electronic system 500. In one or more implementations, bus 508 communicatively connects processing unit(s) 512 with ROM 510, system memory 504, and permanent storage device 502. From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. One or more implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores any of the instructions and data that processing unit(s) 512 needs at runtime. In one or more implementations, the processes of the subject disclosure are stored in system memory 504, permanent storage device 502, and/or ROM 510. From these various memory units, processing unit(s) 512 retrieves instructions to execute and data to process in order to execute the processes of one or more implementations.

Bus 508 also connects to input and output device interfaces 514 and 506. Input device interface 514 enables a user to communicate information and select commands to the electronic system. Input devices used with input device interface 514 include, for example, alphanumeric keyboards and pointing devices (also called “cursor control devices”). Output device interface 506 enables, for example, the display of images generated by electronic system 500. Output devices used with output device interface 506 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, bus 508 also couples electronic system 500 to a network (not shown) through network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to analyze and control an operation or a component may also mean the processor being programmed to analyze and control the operation or the processor being operable to analyze and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for compiling source code, the method comprising:
receiving one or more code stubs configured to be inline cached at one or more call sites of a native code generated by a baseline compiler from a source code, wherein each of the one or more code stubs is based on an intermediate representation between the source code and the native code;
translating the source code into the intermediate representation;
inlining the one or more code stubs into the translated source code; and
optimizing, by an optimizing compiler, at least one of the translated source code and the inlined one or more code stubs.

2. The method of claim 1, further comprising obviating translation, by the optimizing compiler, of the one or more code stubs into the intermediate representation.

3. The method of claim 1, wherein each of the one or more code stubs based on the intermediate representation comprises a corresponding code stub in the intermediate representation.

4. The method of claim 1, wherein each of the one or more code stubs based on the intermediate representation comprises 1) a corresponding code stub in a source code representation and 2) information allowing the corresponding code stub in the source code representation to be generated in the intermediate representation without any runtime type information.

5. The method of claim 1, wherein each of the one or more code stubs based on the intermediate representation excludes a corresponding code stub in assembly language.

6. The method of claim 1, further comprising determining one or more locations in the translated source code for inlining the one or more code stubs.

7. The method of claim 6, wherein the one or more code stubs are inlined into the one or more locations in the translated source code.

8. The method of claim 1, wherein optimizing at least one of the translated source code and the inlined one or more code stubs comprises removing one or more redundant operations from at least one of the translated source code and the inlined one or more code stubs.

9. The method of claim 1, wherein optimizing at least one of the translated source code and the inlined one or more code stubs comprises compiling the inlined one or more code stubs into optimized native code.

10. The method of claim 9, further comprising inline caching the optimized native code at one or more call sites of the native code generated by the baseline compiler.

11. The method of claim 1, wherein optimizing at least one of the translated source code and the inlined one or more code stubs comprises compiling the translated source code and the inlined one or more code stubs into optimized native code.

12. A system comprising:
memory comprising instructions for compiling source code; and
a processor configured to execute the instructions to:
receive one or more code stubs configured to be inline cached at one or more call sites of a native code generated by a baseline compiler from a source code, wherein each of the one or more code stubs is based on an intermediate representation between the source code and the native code;
translate the source code into the intermediate representation;
inline the one or more code stubs into the translated source code; and
optimize, by an optimizing compiler, at least one of the translated source code and the inlined one or more code stubs.

13. The system of claim 12, wherein the processor is configured to execute the instructions to determine one or more locations in the translated source code for inlining the one or more code stubs.

14. The system of claim 13, wherein the one or more code stubs are inlined into the one or more locations in the translated source code.

15. The system of claim 12, wherein optimizing at least one of the translated source code and the inlined one or more code stubs comprises removing one or more redundant operations from at least one of the translated source code and the inlined one or more code stubs.

16. The system of claim 12, wherein optimizing at least one of the translated source code and the inlined one or more code stubs comprises compiling the inlined one or more code stubs into optimized native code.

17. The system of claim 16, wherein the processor is configured to execute the instructions to inline cache the optimized native code at one or more call sites of the native code generated by the baseline compiler.

18. A non-transitory machine-readable medium encoded with executable instructions for a method of compiling source code, the method comprising:
receiving one or more code stubs configured to be inline cached at one or more call sites of a native code generated by a baseline compiler from a source code, wherein each of the one or more code stubs is in an intermediate representation between the source code and the native code;
translating the source code into the intermediate representation;
determining one or more locations in the translated source code for inlining the one or more code stubs;
inlining the one or more code stubs into the one or more locations in the translated source code; and
optimizing, by an optimizing compiler, at least one of the translated source code and the inlined one or more code stubs.

19. The machine-readable medium of claim 18, wherein optimizing at least one of the translated source code and the inlined one or more code stubs comprises removing one or more redundant operations from at least one of the translated source code and the inlined one or more code stubs.

20. The machine-readable medium of claim 18, wherein optimizing at least one of the translated source code and the inlined one or more code stubs comprises compiling the inlined one or more code stubs into optimized native code.
